(19) United States
(12) Patent Application Publication
(10) Pub. No.: US 2025/0131374 A1
(43) Pub. Date: Apr. 24, 2025

(54) RETAIL METHOD FOR COMBINING OFFLINE PERSONALS AND ENTITY RETAIL STORES WITH AN ONLINE SUPPLIER AND SYSTEM THEREOF

(71) Applicant: Keh-Shyong YU, Taichung City (TW)

(72) Inventor: Keh-Shyong YU, Taichung City (TW)

(21) Appl. No.: 18/493,504

(22) Filed: Oct. 24, 2023

(51) Int. Cl. G06Q 10/087

(52) U.S. Cl. CPC G06Q 10/087

(57) ABSTRACT

The present invention discloses a retail system for combining offline personals and entity retail stores with an online supplier and a retail method thereof. A merchandise service platform generates first identification information and first commodity information and outputs the first identification information to a first device. The first commodity information comprises a plurality of first product data. A user device of a consumer reads the first identification information to obtain first business information of a first entity retail store, connects to the merchandise service platform, and reads the first commodity information corresponding to the first business information. Therefore, when the consumer visits the first entity retail store to scan the first identification information, the consumer can purchase the merchandise sold by the first entity retail store on the merchandise service platform via Internet. As a result, the present invention incites the consumer to visit the first entity retail store.

### BACKGROUND OF THE INVENTION

### 1. Field of the Invention

The present invention relates to a method for combining offline personals and entity retail stores with an online supplying service and a system thereof, particularly to a retail method for combining offline personals and entity retail stores with an online supplier and a system thereof.

### 2. Description of the Related Art

With the boom of online shopping, traditional retailers running physical stores have suffered a considerable commercial impact. More and more consumers choose online shopping, replacing the traditional shopping mode of going to the physical store to purchase the merchandise exhibited in the physical store. Therefore, the traditional retailers either close the physical store to stop paying the rent, or turn to sell the merchandise on online shopping platforms.

However, most of the present online shopping platforms focus on maintaining consumers' shopping experience and the benefits of the online shopping platforms itself, but neglect to maintain a benign business relationship between the online shopping platforms and offline traditional retailers. Hence, when offline traditional retailers join the online shopping platforms, the offline traditional retailers still cannot get obvious benefits. Specifically, the business relationship is established on the merchandise, which is sold by the online shopping platforms and provided by the offline traditional retailers. The offline traditional retailers cannot depend on the business relationship to obtain more benefits because consumers purchasing the merchandise on the online shopping platforms easily ignore the offline traditional retailers and are mainly impressed by online shopping platforms only. The traditional offline retailer can earn commissions from the online shopping platforms for selling the merchandise, but the offline traditional retailers cannot attract the consumer to visit the physical store through the merchandise sold by the online shopping platforms. As a result, the offline traditional retailers may experience a decline as consumers have very little engagement with the physical store.

Patent No. TWI696137B is related to an online-to-offline e-commerce system. The patent utilizes a first user device, such as a referrer's mobile phone or a computer, to obtain merchandise recommendation information from a central server. The referrer then transmits the merchandise recommendation information to a second user device owned by the consumer, such as a mobile phone or a computer, etc. If the consumer uses the second user device to purchase the merchandise corresponding to the merchandise recommendation information, the central server will send commission information to the first user device. However, as mentioned above, even if the referrer is the offline traditional retailer, the offline traditional retailer still cannot attract the consumer to visit the physical storefront through the transaction merchandise. As a result, offline traditional retailers may experience a decline in business since consumers have very little engagement with the physical store.

Patent No. CN113920644A relates to an online and offline community fresh food interactive platform for distribution and a method thereof. The patent discloses that fresh food stores can utilize a carriage with wheels to move and sell a fresh merchandise. An offline mobile fresh food store can be linked to an online community fresh food store via a unique mark. After the consumer places an order and pays, the offline mobile fresh food store will receive a benefit. Because the offline mobile fresh food store described here is a movable store, the fresh merchandise can be sold in different locations within the community. Consequently, the movable store is not limited to a fixed location for selling the merchandise, which is different from the aforementioned physical storefront of offline traditional retailers. In other words, the movable fresh store will not become alienated from the consumer and a decline as the movable fresh store itself can increase interactions with the consumer by moving the carriage. Furthermore, the movable fresh store will not be replaced by the online consumer platform. Therefore, the situation and the problems to be solved of the patent are different from those of the present invention.

### SUMMARY OF THE INVENTION

In light of the aforementioned issues, the present invention provides a retail method for combining offline personals and entity retail stores with an online supplier and a system thereof. The retail method and the retail system attract consumers to visit the physical storefront of the offline traditional retailer. The retail method and the retail system further utilize the product information and the products provided by the online merchandise service to reduce rent expenses of the physical store of the traditional retailer and to increase the amount of the consumer visiting the physical store. Accordingly, the offline traditional retailer can prevent being replaced by online shopping platforms due to lack of consumers visiting the physical store.

The retail method for combining the offline personals and entity retail stores with the online supplier includes the following steps:
generating first identification information and first commodity information corresponding to a first entity retail store and outputting the first identification information to a first device corresponding to the first entity retail store by a merchandise service platform; wherein the first commodity information comprises a plurality of first product data;
reading the first identification information to obtain first business information of the first entity retail store, connecting to the merchandise service platform according to the first business information, and reading the first commodity information corresponding to the first business information by a user device;
generating first purchase information corresponding to at least one of the first product data according to the first commodity information and outputting the first purchase information to the merchandise service platform using the user device;
when the merchandise service platform receives the first purchase information generated using the user device, calculating first total amount information corresponding to the first purchase information and first marketing gross profit information corresponding to the first entity retail store by the merchandise service platform;
when the merchandise service platform receives first payment confirmation information generated by a payment platform, generating first marketing gross profit payment information to the payment platform according to the first marketing gross profit information by the merchandise service platform.

The present invention further discloses a retail system combining offline personals and entity retail stores with an online merchandise service, comprising:
a merchandise service platform;
a user device, communicating with the merchandise service platform via an Internet;
a first device, communicating with the merchandise service platform via the Internet;
a payment platform, communicating with the merchandise service platform via the Internet;
wherein the merchandise service platform generates first identification information and first commodity information corresponding to a first entity retail store, and outputs the first identification information to the first device corresponding to the first entity retail store; wherein the first commodity information comprises a plurality of first product data;
wherein the user device reads the first identification information to obtain first business information of the first entity retail store, connects to the merchandise service platform according to the first business information, and reads the first commodity information corresponding to the first business information;
wherein the user device generates purchase information corresponding to at least one of the first product data according to the first commodity information, and outputs the purchase information to the merchandise service platform;
wherein when the merchandise service platform receives the purchase information generated using the user device, the merchandise service platform calculates first total amount information corresponding to the purchase information and first marketing gross profit information corresponding to the first entity retail store;
wherein when the merchandise service platform receives first payment confirmation information generated by the payment platform, the merchandise service platform generates first marketing gross profit payment information according to the first marketing gross profit information to the payment platform.

The key point in the present invention is that as the first identification information obtained by the first device is located within the first entity retail store, the consumer and the user device owned by the consumer need to be present at the first entity retail store to scan the first identification information using the user device. In this manner, the consumer further uses the user device to browse the first commodity information to buy the merchandise via the Internet. This marketing method of the merchandise encourage more consumers to go to the first entity retail store to purchase the specific product. Therefore, the first entity retail store can attract more consumers to visit the physical store to prevent being replaced by online shopping platforms. In other words, to purchase exclusive merchandise in the first entity retail store, the consumer needs to scan the first identification information within the first entity retail store to buy the exclusive merchandise via the Internet. The present invention sustain the relationship between the online merchandise service platform and the offline first entity retail store by encouraging the consumer to visit the physical store of the first entity retail store. Accordingly, when the sales volume of the merchandise sold by the online merchandise service platform increases, the attraction of the first entity retail store can be strengthened according to the sales volume of the merchandise. For consumers, it is easy to scan the first identification information using the user device in the first entity retail store when they go to the first entity retail store. Hence, after making a purchase at the entity retail store, the consumer still can use the user device to purchase another product featured on the merchandise service platform via the Internet. The consumer both purchases the product featured on the merchandise service platform via Internet and visits the physical storefront of the first entity retail store. Consequently, the attraction of the first entity retail store can be maintained and the first entity retail store prevents being replaced by online shopping platforms and experiencing a decline.

### BRIEF DESCRIPTION OF THE DRAWINGS

FIG. 1 is the block diagram of a retail system for combining offline personals and entity retail stores with an online supplier in the present invention;

FIG. 2 is the market mode schematic diagram of a retail method for combining the offline personals and entity retail stores with the online supplier in the present invention; and

FIG. 3A and FIG. 3B are the flowchart of the retail method for combining the offline personals and entity retail stores with the online supplier in the present invention.

### DETAILED DESCRIPTION OF THE INVENTION

The present invention provides a retail method for combining offline personals and entity retail stores with an online supplier and a retail system for combining the offline personals and entity retail stores with the online supplier.

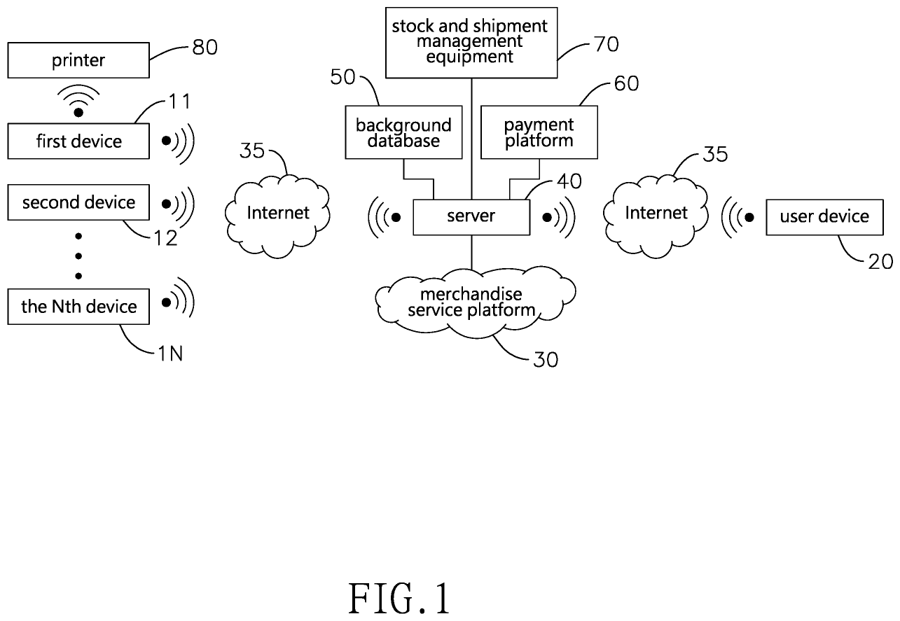

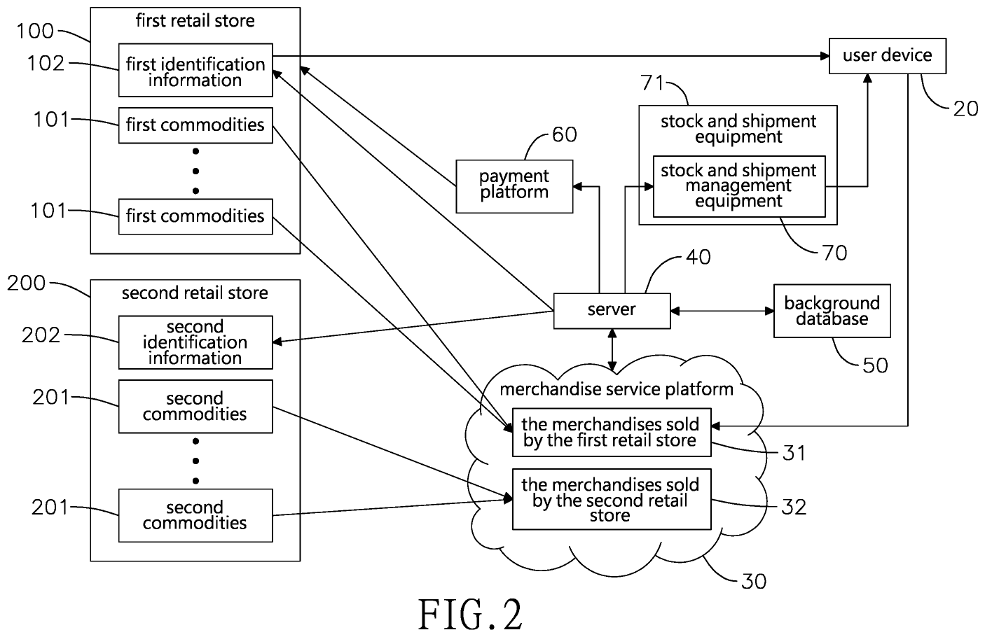

Refer to FIG. 1 and FIG. 2. The retail system for combining the offline personals and entity retail stores with the online supplier comprises a first device 11, a user device 20, and a merchandise service platform 30.

The merchandise service platform 30 is a trading platform built on the cloud. Hardware for building the merchandise service platform 30 is a server 40 set up at a backstage. The server 40 communicates with the Internet 35 and communicates with a background database 50 and a payment platform 60.

Both the first device 11 and the user device 20 are devices for communicating with the Internet 35 and for browsing the merchandise service platform 30. In an embodiment of the present invention, both the first device 11 and the user device 20 are a smartphones and are capable of browsing the merchandise service platform 30 on the Internet 35 via an application (APP) or a browser. In another embodiment, the first device 11 and the user device 20 are either computers with cameras or tablet computers with cameras.

The first device 11 first communicates with the merchandise service platform 30 via the Internet 35, and logs into the merchandise service platform 30 using an account and password to pass an authentication. Accordingly, it confirms that the first device 11 is a device used by a first entity retail store 100. The first entity retail store 100 is a conventional entity retail store, selling a plurality of various first commodities 101 at a fixed position. When a conventional selling mode of the first entity retail store 100 is influenced by an Internet selling mode, the first entity retail store 100 can join the retail system of the present invention to become an entity retail store on the merchandise service platform 30. To display all the first commodities 101 sold in the first entity retail store 100 on the merchandise service platform 30, the first entity retail store 100 uses the first device 11 to take pictures of the first commodities 101 and upload the pictures to the merchandise service platform 30. Further, the first entity retail store 100 provides selling information with prices and illustrations of the first commodities 101. The merchandise service platform 30 stores the selling information in the background database 50 by the server 40. In this way, the merchandise service platform 30 generates first commodity information corresponding to the first entity retail store 100. The first commodity information comprises a plurality of first product data and the first product data correspond to the first commodities 101 sold by the first entity retail store 100.

In addition, the merchandise service platform 30 generates first identification information 102 corresponding to the first entity retail store 100 from the server 40 and outputs the first identification information 102 to the first device 11 corresponding to the first entity retail store 100. After receiving the first identification information 102, the first device 11 displays the first identification information 102 in the first entity retail store 100. Preferably, the first device 11 communicates with a printer 80 and the first device 11 prints the received first identification information 102 by the printer 80. The user of the first entity retail store 100 posts the printed first identification information 102 at the door of the first entity retail store 100 and in the first entity retail store 100 to remarkably display the first identification information 102 to a consumer visiting the first entity retail store 100 for scanning the first identification information 102.

Preferably, the background database 50 corresponding to the merchandise service platform 30 stores first business information corresponding to the first entity retail store 100. The first business information comprises title information and location information of the first entity retail store 100, such as a coordinate or an address and so on. The first business information is encoded in the first identification information 102 by the server 40.

Moreover, the application in the present invention is not limited to the conventional entity retail store such as the first entity retail store 100. The first entity retail store 100 is a physical storefront that a person or an entity owns. The physical storefront can be a storefront that will be established and is managed independently. Before the physical storefront is established, the merchandise that the person or the entity has owned can be supplied. Therefore, even though the first entity retail store 100 has not been established, the person or the entity can show the first identification information 102 to the consumer to beforehand sell the merchandise that the first entity retail store 100 desires to sell via the first identification information 102 generated by the present invention.

The consumer of the present invention uses the user device 20 to communicate via the Internet 35. When the consumer patronizes the physical first entity retail store 100 or the pre-built first entity retail store 100 to prepare to buy the merchandise, the consumer utilizes the user device 20 to scan the first identification information 102 disposed at the door of the first entity retail store 100 in the first entity retail store 100. The user device 20 decodes the first identification information 102 to obtain the first business information of the first entity retail store 100. The user device 20 outputs the first business information to the merchandise service platform 30 to notify the merchandise service platform 30 that the user device 20 used by the consumer is just now at the first entity retail store 100. In addition, the consumer is about to buy the merchandise provided by the first entity retail store 100.

Furthermore, the merchandise service platform 30 receives the first business information from the user device 20 and outputs the first commodity information to the user device 20 according to the first business information. In this way, the first commodities 101 sold by the first entity retail store 100 are exhibited on the merchandise service platform 30. The user device 20 logs in the merchandise service platform 30 from an APP or a browser to browse the first commodities 101 sold by the first entity retail store 100. In this way, the user device 20 reads the first identification information 102 to obtain the first business information of the first entity retail store 100. The user device 20 connects to the merchandise service platform 30 according to the first business information and read the first commodity information corresponding to the first business information.

Preferably, the merchandise service platform 30 exhibits both the first commodities 101 sold by the first entity retail store 100 and other merchandises sold by other stores. However, the first commodities 101 sold by the first entity retail store 100 comprise specific and exclusive merchandises. The specific and exclusive merchandises can be bought on the merchandise service platform 30 via scanning the first identification information 102 using the user device 20. Furthermore, the specific and exclusive merchandises sold by the first entity retail store 100 fail to be regarded as the merchandises of relevant stores and fail to be exhibited on other web pages.

In other words, when the consumer scans the first identification information 102 to browse the merchandises sold by the first entity retail store 31 on the merchandise service platform 30, the merchandises sold by the first entity retail store 31 comprise both the first commodities 101 and well-known and popular products. The well-known and popular products are uncertain to be exhibited in the substantial first entity retail store 100. However, the first commodities 101 comprise the specific and exclusive merchandises sold by the first entity retail store 100, which can be bought by scanning the first identification information 102 in the first entity retail store 100 when the consumer goes to the first entity retail store 100. Moreover, the first identification information 102 does not have to be far away from the first entity retail store 100 as the first entity retail store 100 in the present invention would not display the first identification information 102 at a place far away from the first entity retail store 100 for defending their right.

Furthermore, except for the identification information, the consumer utilizes an augmented reality device or a virtual reality device to browse the merchandises sold by the first entity retail store 31 on the merchandise service platform 30. A store code of the first entity retail store 31 is used as the identification information for being inputted into the augmented reality device or the virtual reality device in advance. Then the consumer uses the phone number as an authentication code corresponding to the identification information to log in the augmented reality device or the virtual reality device. Accordingly, the augmented reality device or the virtual reality device provides an immersive environment for stimulating the consumer to purchase the merchandise on the merchandise service platform 30. The payment method and the benefit calculation are the same as the embodiment of the identification information. Therefore, the details are omitted herein.

In other words, when the consumer uses the first identification information 102 or the second identification information 202 to login the merchandise service platform 30, the merchandise service platform 30 provides a catalog, a static video, and a dynamic video related to the merchandise. Alternatively, when the consumer uses the augmented reality device or the virtual reality device to browse the merchandises on the merchandise service platform 30, the merchandise service platform 30 provides another kind of dynamic video related to the merchandise.

Furthermore, when the consumer utilizes the user device 20 to select the merchandise which the consumer desires to buy, the user device 20 generates first purchase information corresponding to at least one of the first product data according to the first commodity information. The user device 20 further outputs the first purchase information to the merchandise service platform 30. When the merchandise service platform 30 receives the first purchase information generated using the user device 20, the merchandise service platform 30 calculates first total amount information corresponding to the first purchase information and first marketing (retail) gross profit information corresponding to the first entity retail store 100.

After that, the merchandise service platform 30 outputs the first total amount information to the user device 20 and the payment platform 60 and charges a fee for the consumer for using the user device 20 via the payment platform 60. The payment platform 60 is an individually operating external system. When the payment platform 60 confirms that the consumer successfully pays the fee via the user device 20, the payment platform 60 generates first payment confirmation information. Otherwise, the payment platform 60 fails to generate the first payment confirmation information. When the merchandise service platform 30 receives the first payment confirmation information generated by the payment platform 60, the merchandise service platform 30 confirms that the consumer has paid the fee using the user device 20. When the merchandise service platform 30 confirms that the user device 20 has paid the fee via the Internet 35 by the payment platform 60, the merchandise service platform 30 generates first marketing (retail) gross profit payment information to the payment platform 60 according to the first marketing (retail) gross profit information. The merchandise service platform 30 pays a first marketing (retail) gross profit to a first account corresponding to the first entity retail store 100 via the payment platform 60. In this way, the merchandise service platform 30 feedbacks the marketing (retail) gross profit to the first entity retail store 100. The payment platform 60 described in the present invention is a conventional security payment platform system for online trading via the Internet 35 as the details are omitted.

The key point in the present invention is that as the first identification information 102 obtained by the first device 11 is disposed in the first entity retail store 100, the consumer and the user device 20 owned by the consumer needs to go to the first entity retail store 100 to scan the first identification information 102 using the user device 20. In this way, the consumer further uses the user device 20 to browse the first commodity information to buy the merchandise via the Internet 35. Such marketing method of the merchandise incites more consumers to go to the first entity retail store 100 to purchase the specific product. Therefore, the first entity retail store 100 can attract more consumers to visit the physical store to prevent being replaced by online shopping platforms. The present invention maintains the relationship between the online merchandise service platform 30 and the offline first entity retail store 100 by inciting the consumer to visit the physical store of the first entity retail store 100. As a result, when the sales volume of the merchandise sold by the online merchandise service platform 30 boosts, the attraction of the first entity retail store 100 can be reinforced according to the sales volume of the merchandise. For the consumers, it is easy to scan the first identification information 102 via the user device 20 in the first entity retail store 100 when going to the first entity retail store 100. Hence, after the consumer goes to the first entity retail store 100 to purchase the product, the consumer still can use the user device 20 to purchase another product exhibited on the merchandise service platform 30 via the Internet 35. The consumer both purchases the product exhibited on the merchandise service platform 30 via the Internet 35 and visits the physical storefront of the first entity retail store 100. Consequently, the attraction of the first entity retail store 100 can be maintained and the first entity retail store 100 prevents being replaced by online shopping platforms and declining.

In this embodiment, after the consumer pays, the consumers can carry away the merchandise bought from the first entity retail store 100. In another embodiment, the present invention further comprises a stock and shipment equipment 71. A stock and shipment management equipment 70, such as a computer, is disposed in the stock and shipment equipment 71. The stock and shipment management equipment 70 communicates with the server 40 and communicates with the merchandise service platform 30 via the Internet 35. Huge stocks of goods managed by the stock and shipment management equipment 70 for being shipping and purchasing are stored in the stock and shipment equipment 71. Preferably, the stocks comprise major merchandises which can be bought via the merchandise service platform 30. Hence, the stocks comprise all merchandises sold by the first entity retail store 100.

When the merchandise service platform 30 receives the first purchase information generated using the user device 20, the merchandise service platform 30 further generates first shipment information according to the first purchase information and outputs the first shipment information to the stock and shipment management equipment 70. After the stock and shipment management equipment 70 receives the first shipment information, the stock and shipment management equipment 70 controls the stock and shipment equipment 71 to ship out the stock corresponding to the merchandise according to the first shipment information, wherein the stock is shipped to the address written by the consumer via the user device 20. As a result, the order is completed.

In addition, when the merchandise service platform 30 receives the first payment confirmation information generated by the payment platform 60, the merchandise service platform 30 generates a trade record and stores the trade record in the background database 50 for being checked.

According to above descriptions, after the consumer goes to the first entity retail store 100 to purchase the merchandise, place the order, and pay by the online merchandise service platform 30, the online merchandise service platform 30 dispatches the merchandise to the first entity retail store 100 or a designated place according to the first purchase information. In other words, purchasing the merchandise, placing the order, and paying are online actions and dispatching the merchandise is an offline action. Therefore, the online merchandise service platform 30 is capable of combining the online actions and the offline action.

Furthermore, except for the first device 11 corresponding to the first entity retail store 100, the retail system in the present invention communicates with various stores from all walks of life. For instance, a second entity retail store 200 realizes that the first entity retail store 100 achieves success and desires to join the retail system, the user of the first entity retail store 200 can utilize a second device 12 to join the retail system. The second device 12 communicates with the merchandise service platform 30 via the Internet 35. When the user of the Nth entity retail store desires to join the retail system, the user can utilize the Nth device to join the retail system. The Nth device communicates with the merchandise service platform 30 via the Internet 35, wherein N is a positive integer greater than two. For convenience to illustrate, the descriptions mentioned below take the second entity retail store 200 and the second device 12 corresponding to the second entity retail store 200 as an example. Generally, the principle and mode of the second entity retail store 200 and the second device 12 are the same as those of the first entity retail store 100 and the first device 11. The merchandise service platform 30 in the present system generates unique second identification information 202 and a second commodity information corresponding to the second entity retail store 200 and outputs the second identification information 202 to the second device 12 corresponding to the second entity retail store 200. The second commodity information comprises a plurality of second product data corresponding to a plurality of second commodities 201 sold by the second entity retail store 200. The second product data and second business information of the second entity retail store 200 are stored in the background database 50. The second business information is encoded in the second identification information 202 by the server 40.

The user device 20 scans the second identification information 202 to obtain the second business information of the second entity retail store 200. The user device 20 connects to the merchandise service platform 30 according to the second business information and reads the second commodity information corresponding to the second business information. The consumer scans the second identification information 202 to browse the commodity in the second entity retail store 32 on the merchandise service platform 30. The commodity in the second entity retail store 32 comprises both the second commodities 201 and widely-circulated and popular products. The second commodities 201 comprise the exclusive merchandises in the second entity retail store 200, that is, the merchandise fails to be sold in the first entity retail store 100.

After browsing the merchandise 32 sold by the second entity retail store, the consumer purchases the merchandise 32 via the user device 20. The user device 20 generates second purchase information corresponding to at least one of the second product data according to the second commodity information. The user device 20 further outputs the second purchase information to the merchandise service platform 30.

When the merchandise service platform 30 receives the second purchase information generated using the user device 20, the merchandise service platform 30 calculates second total amount information corresponding to the second purchase information and calculates second marketing (retail) gross profit information corresponding to the second entity retail store 200. The merchandise service platform 30 further charges another fee to the user device 20 via the payment platform 60.

When the merchandise service platform 30 confirms that the user device has paid another fee via the payment platform 60, that is, when the merchandise service platform 30 receives second payment confirmation information generated by the payment platform 60, the merchandise service platform 30 generates second marketing (retail) gross profit payment information to the payment platform 60 according to the second marketing (retail) gross profit information. The merchandise service platform 30 further pays a second marketing (retail) gross profit to a second account corresponding to the second entity retail store 200 via the payment platform 60. In this way, the merchandise service platform 30 transfers the second marketing (retail) gross profit to the second entity retail store 200.

In the embodiment, the consumer can scan the identification information to perchance the merchandise via the Internet 35 without registering a member of the merchandise service platform 30. Alternatively, the consumer can register the member of the merchandise service platform 30 to facilitate the background database 50 of the retail system to store the cost record, Online shopping information, and the reward points. After the consumer accumulates multiple trades, the merchandise service platform 30 renders the consumer a lower price of the merchandise. Moreover, the store becomes the member of the merchandise service platform 30, that is, the first entity retail store 100 utilizing the first device 11 and the second entity retail store 200 utilizing the second device 12 can accumulate a score each time after the consumer purchases the merchandise. As a result, the first entity retail store 100 and the second entity retail store 200 gain more marketing (retail) gross profits according to the accumulated score. In other words, if a transaction volume of the first entity retail store 100 is greater than a transaction volume of the second entity retail store 200, or a number of the first identification information 102 corresponding to the first entity retail store 100 scanned by the consumers is greater than a number of the second identification information 202 corresponding to the second entity retail store 200 scanned by the consumers, a percentage of the first marketing (retail) gross profit corresponding to the first account of the first entity retail store 100 paid by the merchandise service platform 30 via the payment platform 60 is greater than a percentage of the second marketing (retail) gross profit corresponding to the second account of the second entity retail store 200 paid by the merchandise service platform 30 via the payment platform 60. The percentage of the first marketing (retail) gross profit is greater than the percentage of the second marketing (retail) gross profit, which represents that the first marketing (retail) gross profit accounts for over the percent of the total amount of the transaction. As a result, the present invention promotes the store to sell the exclusive product with competitiveness on the merchandise service platform 30. Therefore, the present invention improves the competitiveness of the store on the merchandise service platform 30 so that the consumer has greater desires to visit the physical storefront. For instance, the first identification information 102 and the second identification information 202 are a quick response code: QR code.

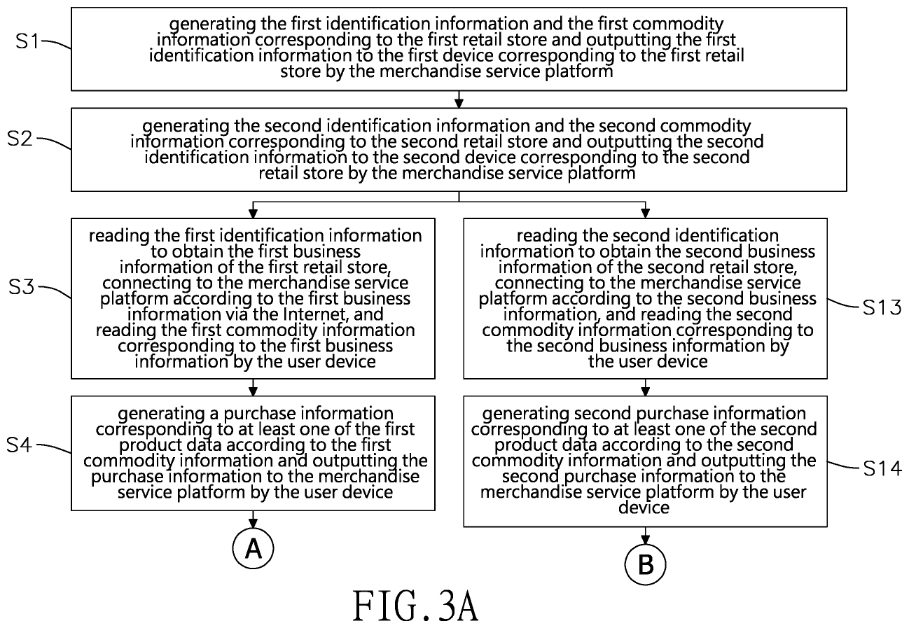

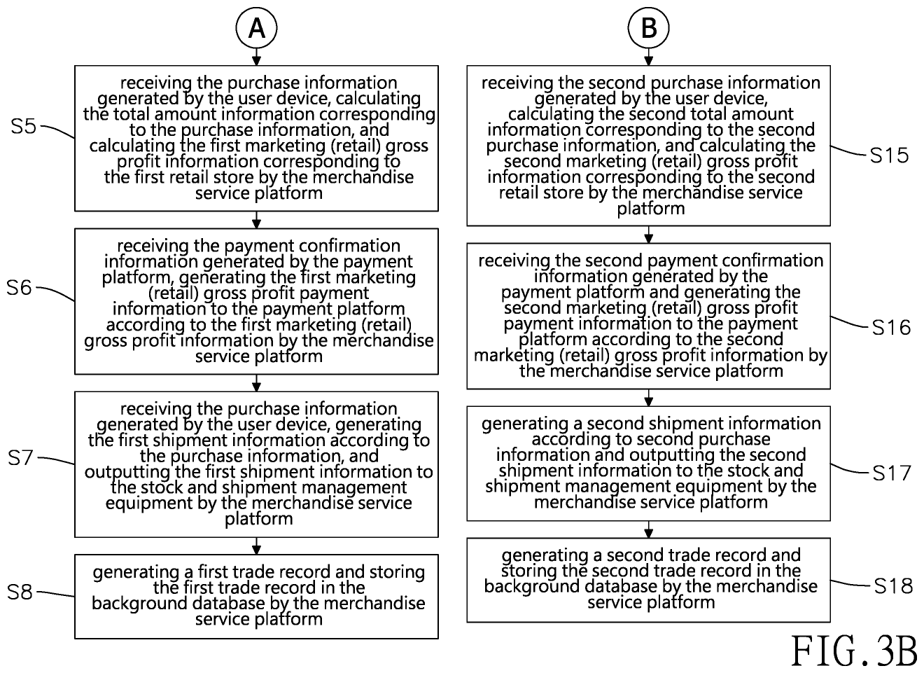

Refer to FIG. 3A and FIG. 3B, in view of the aforementioned retail system combining offline personals and entity retail stores with an online merchandise service, the retail method combining offline personals and entity retail stores with an online merchandise service in the present invention is performed by the retail system. In the aforementioned embodiments, the retail method combining offline personals and entity retail stores with an online merchandise service comprises the following steps.

Step S1 is that the merchandise service platform 30 generates the first identification information 102 and the first commodity information corresponding to the first entity retail store 100 and outputs the first identification information 102 to the first device 11 corresponding to the first entity retail store 100. As mentioned above, the first commodity information comprises the first product data.

Step S2 is that the merchandise service platform 30 generates the second identification information 202 and the second commodity information corresponding to the second entity retail store 200 and outputs the second identification information 202 to the second device 12 corresponding to the second entity retail store 200. As mentioned above, the second commodity information comprises the second product data.

After that, the retail method is distinguished different steps according to identification information scanned using the user device 20 of the consumer. When the identification information scanned using the user device 20 is the first identification information 102, the retail method combining offline personals and entity retail stores with an online merchandise service performs the following step S3 to step S8.

Step S3 is that the user device 20 reads the first identification information 102 to obtain the first business information of the first entity retail store 100, connects to the merchandise service platform 30 according to the first business information via the Internet 35, and reads the first commodity information corresponding to the first business information.

Step S4 is that the user device 20 generates purchase information corresponding to at least one of the first product data according to the first commodity information and outputs the purchase information to the merchandise service platform 30.

Step S5 is that when the merchandise service platform 30 receives the purchase information generated using the user device 20, the merchandise service platform 30 calculates the total amount information corresponding to the purchase information and calculates the first marketing (retail) gross profit information corresponding to the first entity retail store 100.

Step S6 is that when the merchandise service platform 30 receives the payment confirmation information generated by the payment platform 60, the merchandise service platform 30 generates the first marketing (retail) gross profit payment information to the payment platform 60 according to the first marketing (retail) gross profit information.

Step S7 is that when the merchandise service platform 30 receives the purchase information generated using the user device 20, the merchandise service platform 30 generates the first shipment information according to the purchase information and outputs the first shipment information to the stock and shipment management equipment 70.

Step S8 is that when the merchandise service platform 30 receives the payment confirmation information generated by the payment platform 60, the merchandise service platform 30 generates a first trade record and stores the first trade record in the background database 50.

When the identification information scanned using the user device 20 is the second identification information 202, the retail method combining an offline personals and entity retail stores with an online merchandise service performs the following step S13 to step S18.

Step S13 is that the user device 20 reads the second identification information 202 to obtain the second business information of the second entity retail store 200, connects to the merchandise service platform 30 according to the second business information, and reads the second commodity information corresponding to the second business information.

Step S14 is that the user device 20 generates second purchase information corresponding to at least one of the second product data according to the second commodity information and outputs the second purchase information to the merchandise service platform 30.

Step S15 is that when the merchandise service platform 30 receives the second purchase information generated using the user device 20, the merchandise service platform 30 calculates the second total amount information corresponding to the second purchase information and calculates the second marketing (retail) gross profit information corresponding to the second entity retail store 200.

Step S16 is that when the merchandise service platform 30 receives the second payment confirmation information generated by the payment platform 60, the merchandise service platform 30 generates the second marketing (retail) gross profit payment information to the payment platform 60 according to the second marketing (retail) gross profit information.

Step S17 is that when the merchandise service platform 30 receives second purchase information generated using the user device 20, the merchandise service platform 30 generates second shipment information according to second purchase information and outputs the second shipment information to the stock and shipment management equipment 70.

Step S18 is that when the merchandise service platform 30 receives second payment confirmation information generated by the payment platform 60, the merchandise service platform 30 generates a second trade record and stores the second trade record in the background database 50.

Furthermore, in a country having vast areas such as American, major part of small or medium cities fail to dispose hypermarkets such as Costco. For residents living in the small or medium cities, they cannot conveniently visit the hypermarkets to purchase best-selling merchandises displayed in the hypermarkets because they need to drive a car for a long distance. The invention facilitates that the consumer both visits the best-selling merchandises featured on the merchandise service platform via Internet and promotes desires to purchase the best-selling merchandises. After the consumer purchases the best-selling merchandises, the stock and shipment equipment will deliver the best-selling merchandises to the address that the consumer assigns. Therefore, the small or medium cities do not need to dispose more hypermarkets, the best-selling merchandises can be purchased more, and cost of the hypermarkets can be reduced.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A retail method for combining offline personals and entity retail stores with an online supplier, comprising steps as follows:
generating first identification information and first commodity information corresponding to a first entity retail store, and outputting the first identification information to a first device corresponding to the first entity retail store by a merchandise service platform; wherein the first commodity information comprises a plurality of first product data;
reading the first identification information by a user device to obtain first business information of the first entity retail store, connecting to the merchandise service platform according to the first business information, and reading the first commodity information corresponding to the first business information using the user device;
generating first purchase information corresponding to at least one of the first product data according to the first commodity information and outputting the first purchase information to the merchandise service platform using the user device;
when the merchandise service platform receives the first purchase information generated using the user device, calculating a first total amount information corresponding to the first purchase information and first marketing gross profit information corresponding to the first entity retail store by the merchandise service;
when the merchandise service platform receives first payment confirmation information generated by a payment platform, generating first marketing gross profit payment information for the payment platform according to the first marketing gross profit information by the merchandise service platform.

2. The retail method for combining the offline personals and entity retail stores with the online supplier as claimed in claim 1, wherein the first device communicates with a printer and the first device prints the first identification information via the printer.

3. The retail method for combining the offline personals and entity retail stores with the online supplier as claimed in claim 1, wherein when the merchandise service platform receives the first purchase information generated using the user device, the merchandise service platform further performs steps as follows:
generating shipment information according to the first purchase information, and outputting the shipment information to a stock and shipment management equipment.

4. The retail method for combining the offline personals and entity retail stores with the online supplier as claimed in claim 1, further comprising steps as follows:
generating second identification information and second commodity information corresponding to a second entity retail store by the merchandise service platform, and outputting the second identification information to a second device corresponding to the second entity retail store; wherein the second commodity information comprises a plurality of second product data;
reading the second identification information using the user device to obtain second business information of the second entity retail store, connecting to the merchandise service platform according to the second business information, and reading the second commodity information corresponding to the second business information using the user device;
generating second purchase information corresponding to at least one of the second product data using the user device according to the second commodity information and outputting the second purchase information to the merchandise service platform;
when the merchandise service platform receives the second purchase information generated using the user device, calculating a second total amount information corresponding to the second purchase information and second marketing gross profit information corresponding to the second entity retail store by the merchandise service platform;
when the merchandise service platform receives second payment confirmation information generated by the payment platform, generating second marketing gross profit payment information according to the second marketing gross profit information to the payment platform by the merchandise service platform.

5. The retail method for combining the offline personals and entity retail stores with the online supplier as claimed in claim 1, wherein the first identification information comprises a position of the first entity retail store, and the retail method further comprises steps as follows:
when the merchandise service platform receives the payment confirmation information generated by the payment platform, generating a trade record and storing the trade record in a background database by the merchandise service platform.

6. A retail system for combining offline personals and entity retail stores with an online supplier, comprising:
a merchandise service platform;
a user device, communicating with the merchandise service platform via an Internet;
a first device, communicating with the merchandise service platform via the Internet;
a payment platform, communicating with the merchandise service platform via the Internet;
wherein the merchandise service platform generates first identification information and first commodity information corresponding to a first entity retail store, and outputs the first identification information to the first device corresponding to the first entity retail store; wherein the first commodity information comprises a plurality of first product data;
wherein the user device reads the first identification information to obtain first business information of the first entity retail store, connects to the merchandise service platform according to the first business information, and reads the first commodity information corresponding to the first business information;
wherein the user device generates purchase information corresponding to at least one of the first product data according to the first commodity information and outputs the purchase information to the merchandise service platform;
wherein when the merchandise service platform receives the purchase information generated using the user device, the merchandise service platform calculates first total amount information corresponding to the purchase information and first marketing gross profit information corresponding to the first entity retail store;
wherein when the merchandise service platform receives first payment confirmation information generated by the payment platform, the merchandise service platform generates first marketing gross profit payment information according to the first marketing gross profit information to the payment platform.

7. The retail system for combining the offline personals and entity retail stores with the online supplier as claimed in claim 6, wherein the first device communicates with a printer and the first device prints the first identification information via the printer.

8. The retail system for combining the offline personals and entity retail stores with the online supplier as claimed in claim 6, further comprising:
a stock and shipment equipment, communicating with the merchandise service platform via the Internet;
wherein when the merchandise service platform receives the purchase information generated using the user device, the merchandise service platform further generates shipment information according to the purchase information and outputs the shipment information to a stock and shipment management equipment.

9. The retail system for combining the offline personals and entity retail stores with the online supplier as claimed in claim 6, further comprising:
a second device, communicating with the merchandise service platform via the Internet;
wherein the merchandise service platform generates second identification information and second commodity information corresponding to a second entity retail store and outputs the second identification information to the second device corresponding to the second entity retail store; wherein the second commodity information comprises a plurality of second product data;
wherein the user device reads the second identification information to obtain second business information of the second entity retail store, connects to the merchandise service platform according to the second business information, and reads the second commodity information corresponding to the second business information;
wherein the user device generates second purchase information corresponding to at least one of the second product data according to the second commodity information, and outputs the second purchase information to the merchandise service platform;
wherein when the merchandise service platform receives the second purchase information generated using the user device, the merchandise service platform calculates second total amount information corresponding to the second purchase information and a second marketing gross profit information corresponding to the second entity retail stores;
wherein when the merchandise service platform receives second payment confirmation information generated by the payment platform, the merchandise service platform generates a second marketing gross profit payment information according to the second marketing gross profit information to the payment platform.

10. The retail system for combining the offline personals and entity retail stores with the online supplier as claimed in claim 6, further comprising:
a background database, communicating with the merchandise service platform via the Internet;
wherein the first identification information comprises position information of the first entity retail store, and when the merchandise service platform receives the payment confirmation information generated by the payment platform, the merchandise service platform generates a trade record and stores the trade record in the background database.

11. The retail system for combining the offline personals and entity retail stores with the online supplier as claimed in claim 6, further comprising:
an augmented reality device, browsing the merchandise sold by the first entity retail store on the merchandise service platform;
wherein the a store code of the first entity retail store is used as the identification information for being inputted into the augmented reality device.

12. The retail system for combining the offline personals and entity retail stores with the online supplier as claimed in claim 11, wherein a phone number is used as an authentication code corresponding to the identification information to log in the augmented reality device.

13. The retail system for combining the offline personals and entity retail stores with the online supplier as claimed in claim 6, further comprising:
a virtual reality device, browsing the merchandise sold by the first entity retail store on the merchandise service platform;
wherein the a store code of the first entity retail store is used as the identification information for being inputted into the augmented reality device.

14. The retail system for combining the offline personals and entity retail stores with the online supplier as claimed in claim 13, wherein a phone number is used as an authentication code corresponding to the identification information to log in the augmented reality device.
